(19) United States
(12) Patent Application Publication
(10) Pub. No.: US 2025/0333252 A1
(43) Pub. Date: Oct. 30, 2025

(54) CONVEYOR LOADING ZONE IMPACT CRADLE AND CONVEYOR WITH LOADING ZONE IMPACT CRADLE

(71) Applicant: Superior Industries, Inc., Morris, MN (US)

(72) Inventors: Paul D. Schmidgall, Morris, MN (US); James Solvie, Morris, MN (US)

(21) Appl. No.: 19/190,351

(22) Filed: Apr. 25, 2025

Related U.S. Application Data
(60) Provisional application No. 63/639,432, filed on Apr. 26, 2024.

(51) Int. Cl. B65G 41/00; B65G 15/08

(52) U.S. Cl. CPC B65G 41/006; B65G 15/08; B65G 2207/28

(57) ABSTRACT

Impact cradle embodiments are provided for supporting a conveyor belt in the area of a loading zone of a conveyor, as well as conveyors including one or more embodiments of such impact cradles. In some embodiments the impact cradle includes a plurality of removable pads supported on a plurality of transverse supports. The transverse supports are optionally disposed at a first height and a second height different from the first height.

### BACKGROUND

Impact cradles are used to at least partially support a conveyor belt of a conveyor in or near a loading zone of the conveyor.

### BRIEF DESCRIPTION OF THE DRAWINGS

FIG. 1 is a perspective view of an embodiment of an impact cradle.

FIG. 2 is a perspective view of the impact cradle of FIG. 1 with a retaining clip not shown.

FIG. 3 is a perspective view of the impact cradle of FIG. 1 with a retaining clip and pad assembly not shown.

FIG. 4 is a side elevation view of the impact cradle of FIG. 1 with a retaining clip and pad assembly not shown.

FIG. 5 is a front elevation view of the impact cradle of FIG. 1 with a retaining clip and pad assembly not shown.

FIG. 6 is a view of the impact cradle of FIG. 1 along the view 6-6 of FIG. 5 with a retaining clip not shown and a pad assembly shown.

FIG. 7 is a perspective view of an embodiment of a pad element of a pad assembly. FIG. 8 is a side elevation view of the pad element of FIG. 7.

### DESCRIPTION

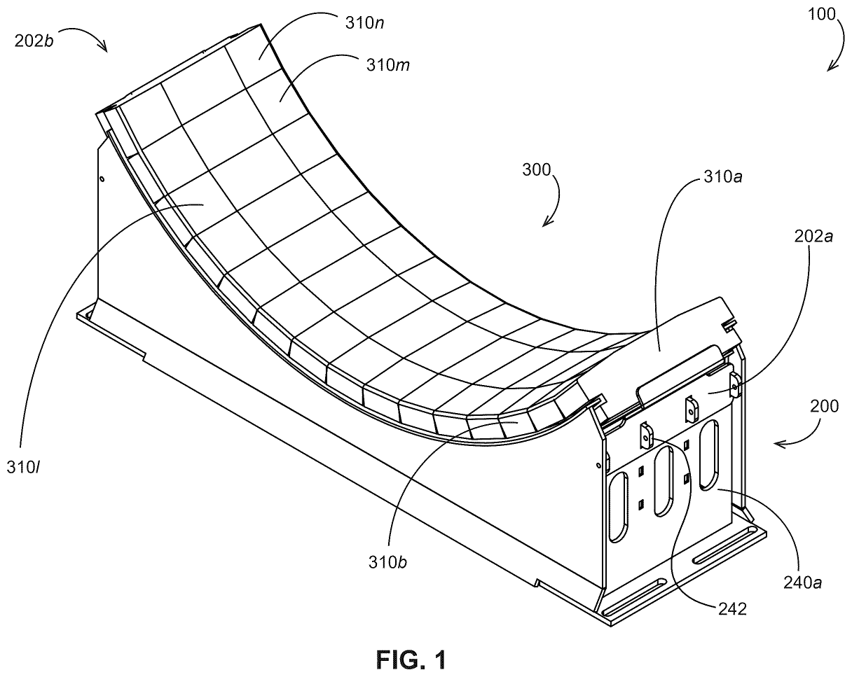

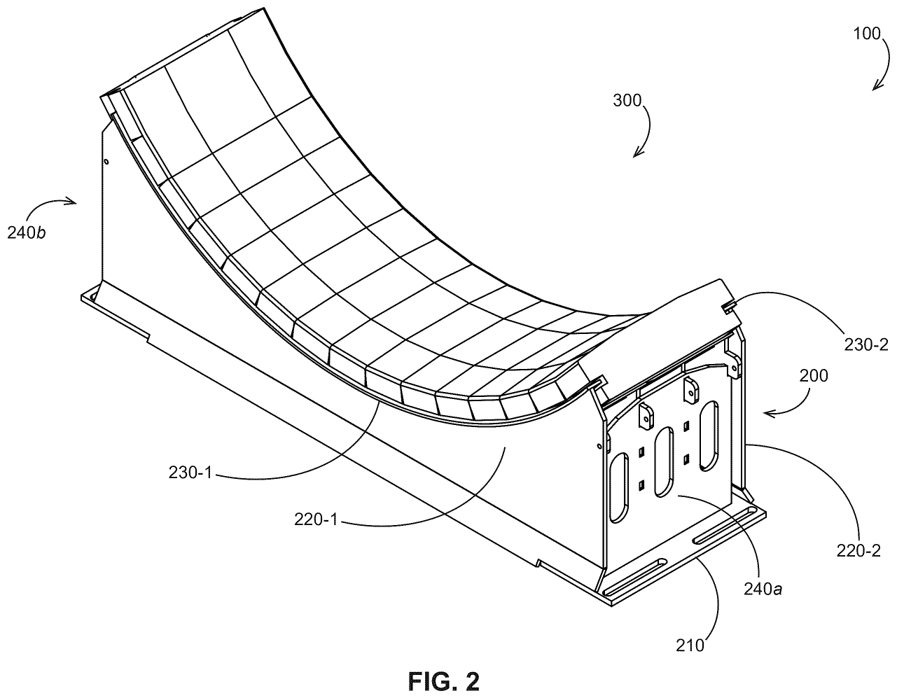

Referring to the drawings, wherein like reference numerals designate identical or corresponding parts throughout the several views, FIGS. 1-6 illustrate an embodiment of an impact cradle 100.

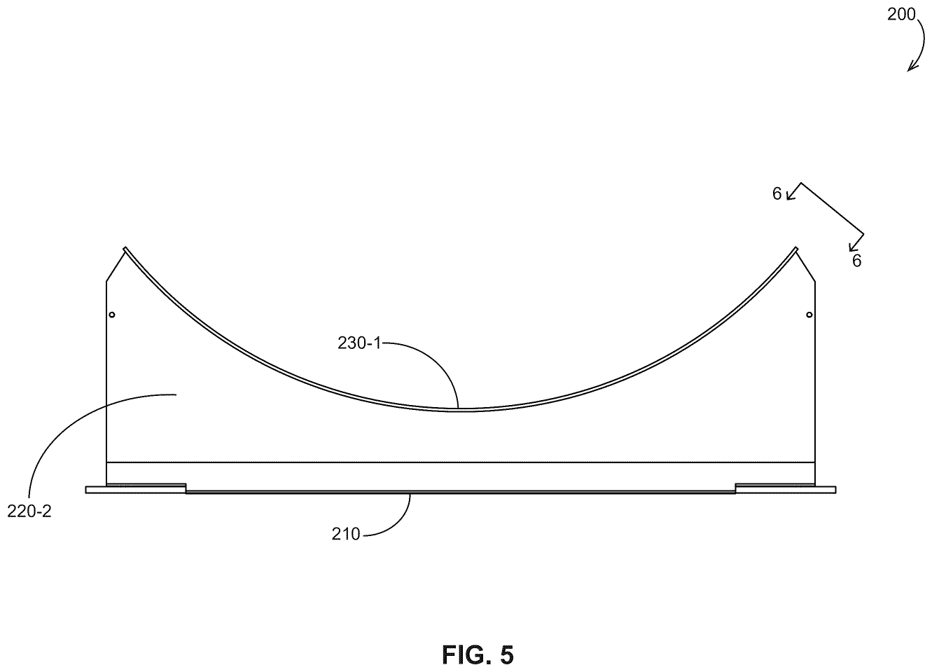

Referring to FIG. 1, impact cradle 100 comprises a frame 200 and a pad assembly 300 to at least partially support a conveyor belt in the area of a loading zone of a conveyor. Pad assembly 300 optionally comprises a plurality of pads 310 (e.g., pads 310a through 310n as illustrated). Each pad 310 optionally comprises a resilient material (e.g., rubber, urethane, etc.); in some embodiments one or more pads 310 optionally comprises a layer (e.g., upper layer) of a different material (e.g., UHMW, a wear resistant material, etc.). Pads 310 are optionally supported (e.g., removably supported) along a width of frame 200. In one embodiment, the Pads 310 are optionally disposed in side-by-side relation. Each pad 310 is optionally removable (e.g., slidingly removable) from frame 200. In some embodiments, pads 310 are removable from frame 200 in succession from left to right or right to left (e.g., right and left on the view of FIG. 5) such as by sliding the pads along a left or right direction. In some embodiments, pad assembly 300 is retained in place by one or more retainer clips 202 (e.g., a right retainer clip 202a and a left retainer clip 202b) of the frame 200. One or more retainer clips 202 are optionally removably and/or movably attached to the remainder of the frame 200 such as by one or more attachment ears 242 and/or one or more fasteners and/or pivotal connectors (not shown).

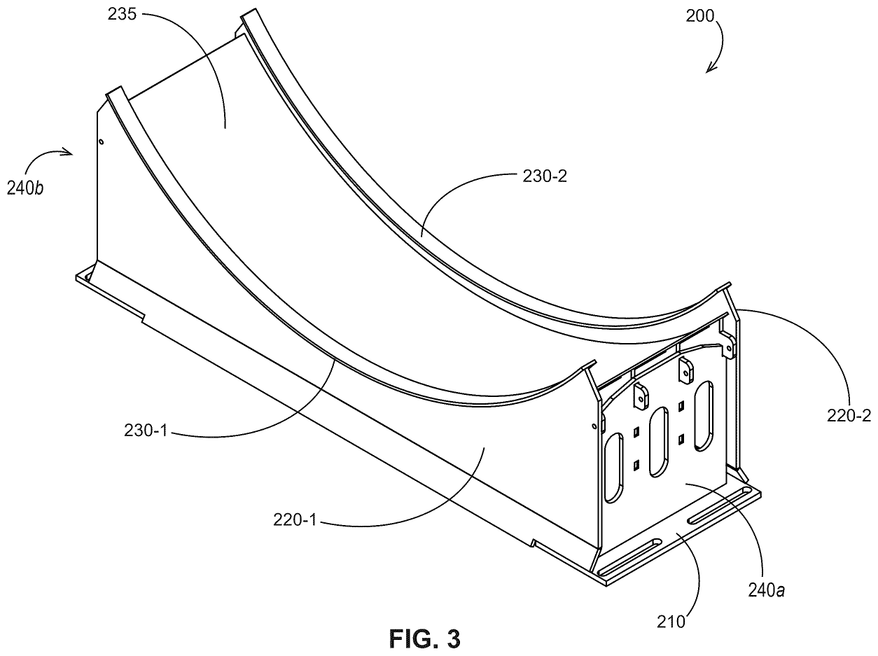

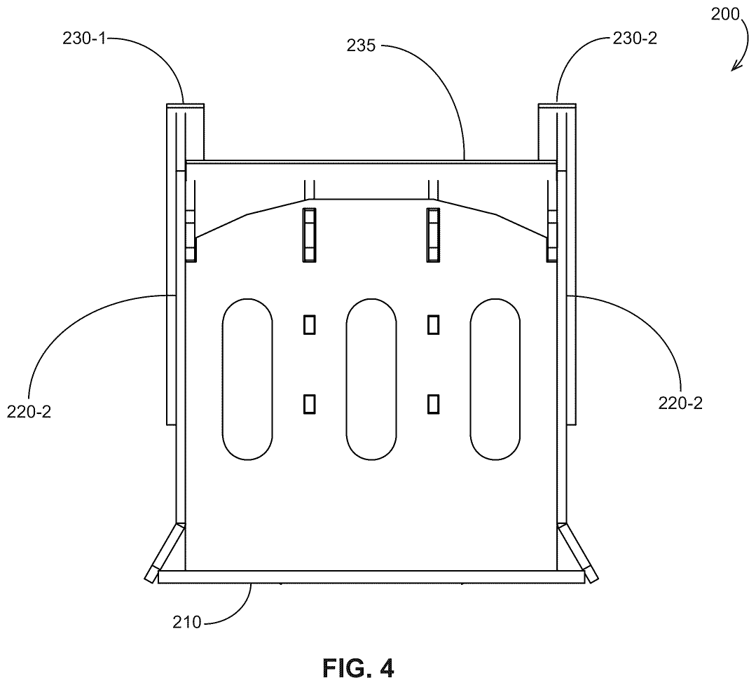

Referring to FIG. 3, the frame 200 is illustrated with both the retainer clips removed and with the pad assembly not installed on the frame. Frame 200 optionally comprises a base 210 which is optionally configured to be supported (e.g., mounted directly or indirectly to and/or between support rails or other structure) on a conveyor such as in the loading zone of the conveyor. Frame 200 optionally comprises a plurality of upper supports 230 (e.g., support 230-1 and support 230-2). Pads 310 are optionally removable from frame 200 by sliding each pad relative to the supports 230 along an arcuate path extending in the right or left direction (e.g., right or left on the view of FIG. 5). Frame 200 optionally comprises a lower support 235. Supports 230 are optionally arcuate, e.g., downwardly arcuate as illustrated. Lower support 235 is optionally arcuate, e.g., downwardly arcuate as illustrated. Upper support 230-1 is optionally parallel to upper support 230-2. Upper support 230-1 is optionally disposed at the same height as upper support 230-2. Lower support 235 is optionally parallel to upper support 230-1 and/or upper support 230-2.

Continuing to refer to FIG. 3, upper support 230-1 is optionally supported on (e.g., mounted to, welded to, etc.) a wall 220-1 of the frame 200. Upper support 230-2 is optionally supported on (e.g., mounted to, welded to, etc.) a wall 220-2 of the frame 200. The frame 200 optionally comprises sidewalls 240a and 240b extending between and connecting the walls 220. Some or all of the walls 220 and sidewalls 240 of the frame 200 are optionally supported on and/or mounted to base 210. Each wall 220 optionally has an upper surface with a curvature parallel to the curvature of the associated support 230.

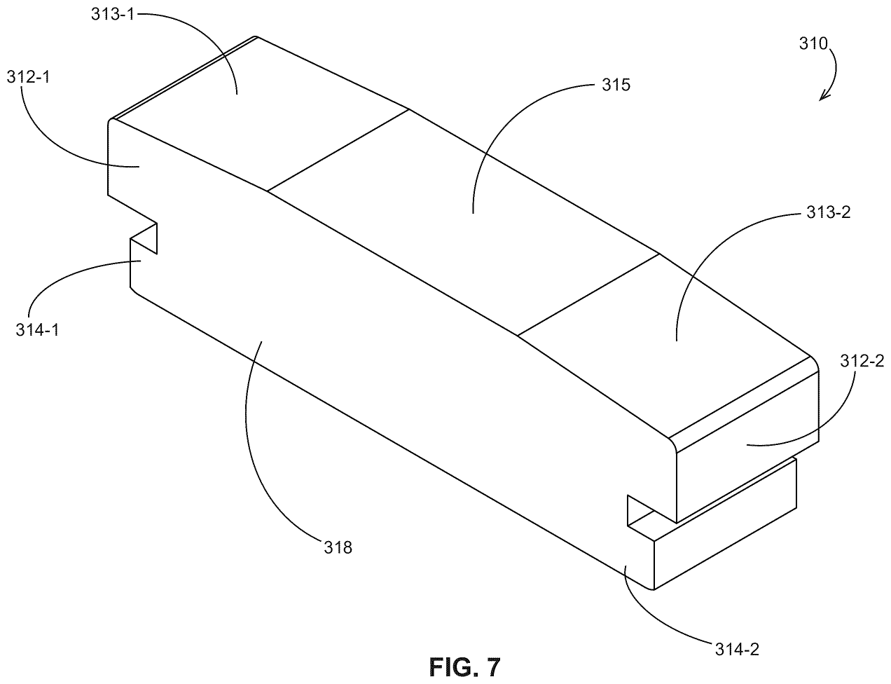

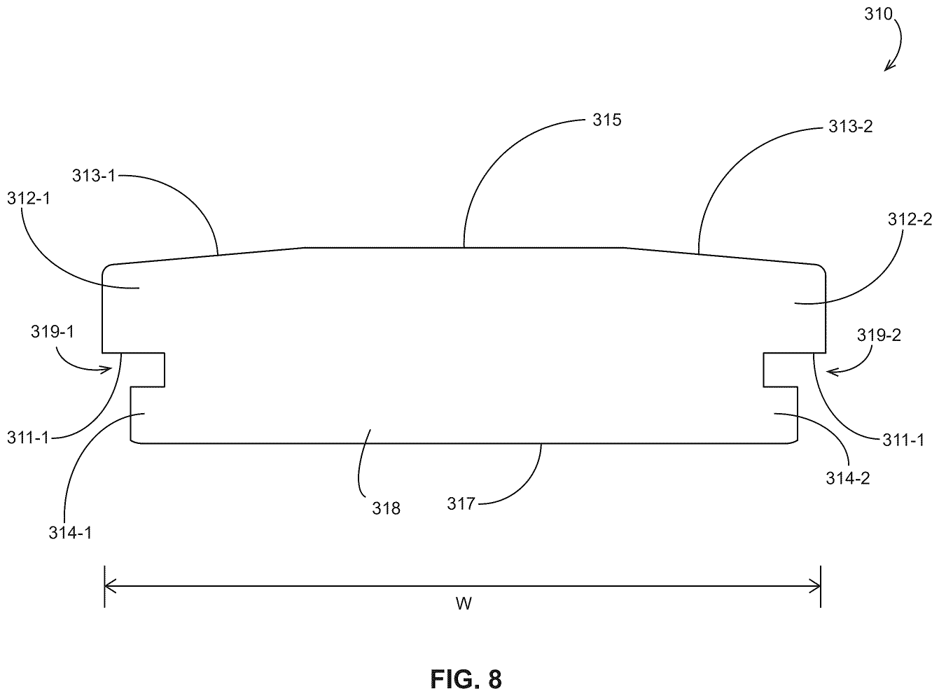

Referring to FIGS. 7 and 8, an embodiment of pad 310 is illustrated in more detail. The pad 310 optionally comprises an upper surface 315 and optionally comprises upper end surfaces 313-1 and 313-2 which are optionally angled (e.g., downwardly) with respect to the upper surface 315. Pad 310 optionally comprises upper end portions 312-1, 312-2 disposed on either side thereof at an upper end thereof. Pad 310 optionally comprises lower end portions 314-1, 314-2 disposed on either side thereof at a lower end thereof. Pad 310 optionally comprises undercuts 319-1, 319-2 disposed on either side thereof. Each undercut is optionally disposed vertically between an upper end portion 312 and a lower end portion 314 on the associated side of the pad 310. Upper end portion 312-1 optionally comprises a lower surface 311-1. Lower surface 311-1 optionally comprises an upper boundary of undercut 319-1. Upper end portion 312-2 optionally comprises a lower surface 311-2. Lower surface 311-2 optionally comprises an upper boundary of undercut 319-2. Pad 310 optionally comprises a lower portion 318. Lower portion 318 optionally comprises a lower surface 317.

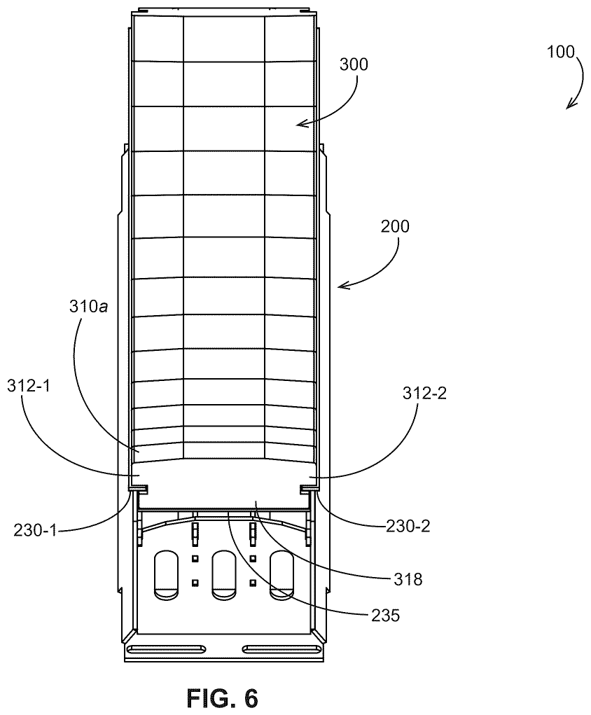

Referring to FIG. 6, in some embodiments the lower support 235 of frame 200 engages and at least partially supports the lower surface 317 of the lower portion 318 of one, a plurality, or all of the pads 310. In some embodiments the upper support 230-1 of frame 200 engages and at least partially supports the lower surface 311-1 of the upper end portion 312-1 of one, a plurality, or all of the pads 310. In some embodiments the upper support 230-2 of frame 200 engages and at least partially supports the lower surface 311-2 of the upper end portion 312-2 of one, a plurality, or all of the pads 310.

Continuing to refer to FIG. 6, it should be appreciated that any upward movement of pad 310 (e.g., after being impacted by material dropping onto and/or deflecting off of the impact cradle 100) is at least partially prevented or restrained by contact of the edge portion 314-1 with the support 230-1 and by contact of the edge portion 314-2 with the support 230-2.

With reference to FIGS. 1-6, it should be appreciated that the undercuts 319-1 of the series of installed pads 310 of assembly 300 form an arcuate transversely extending groove engaging the support 230-1. Likewise, undercuts 319-2 of the series of installed pads 310 of assembly 300 form an arcuate transversely extending groove engaging the support 230-2.

With reference to FIGS. 6 and 8, it should be appreciated that in some embodiments, the supports 230-1, 230-2 and 235 cooperatively support an entire width W (i.e., along an entirety of the width W) of the impact pad 310. In some embodiments, support 230-1 supports a first portion of width W (e.g., first end portion of width W), support 235 supports a second portion of width W (e.g., central portion of width W), and support 230-2 supports a third portion of width W (e.g., second end portion of width W). In some embodiments, the first end portion of width W partially overlaps with second portion of width W and second end portion of width W partly overlaps with third end portion of width W.

In alternative embodiments, a smaller or greater number of pads are included in the pad assembly. In alternative embodiments, a single transversely extending pad is used instead of a plurality of pads. In some embodiments, the supports 230 and/or support 235 do not extend along the entire transverse width of the impact cradle.

In alternative embodiments, the supports 230 and/or support 235 comprises a plurality of separate segments extending at least partially across portions of the transverse width of the impact cradle. In alternative support 235 comprises one or more drain holes or elongate slots.

In alternative embodiments, the supports 230 have different cross-sectional shapes (e.g., round, rectangular, square, etc.). In alternative embodiments, the supports 230 extend into an undercut of the pad or pads extending upward through a bottom surface of the pad.

In various embodiments, conveyors comprising impact cradle embodiments described herein may be self-standing and/or may be incorporated in a plant having other equipment thereon (e.g., crushers, vibratory screens, vibratory feeders, crushers, impactors, hoppers, further conveyors, etc.). The conveyor embodiments and/or plant embodiments including such impact cradle embodiments may be stationary or portable (e.g., supported on skids, tracks, or wheels) according to various embodiments.

Reference numerals recited with the suffixes -1 and -2 indicate that in at least one of various embodiments, the objects of the reference numerals comprise a corresponding (e.g., structurally similar, structurally identical, identical, symmetrical, similar, functionally similar, functionally identical, etc.) pair. In any instance where a reference numeral is shown with one of the suffixes -1 or -2 and the reference numeral with the other suffix is omitted from the drawings and/or the written description, it is hereby positively recited that there is at least one embodiment including the unwritten, unlabeled, and/or unillustrated element.

Reference numerals recited with sequential letter suffixes (e.g., a, b, c, etc.) indicate that the objects of the reference numerals comprise a series of corresponding (e.g., structurally similar, structurally identical, identical, similar, functionally similar, functionally identical, etc.) objects. In any instance where a letter suffix (e.g., c) is used and one or more of the preceding letter suffixes (e.g., a, b) are omitted from the drawings and/or the written description, it is hereby positively recited that there is at least one embodiment including the omitted corresponding objects in the series.

Any ranges recited herein are intended to inclusively recite all values and sub-ranges within the range provided in addition to the maximum and minimum range values. Headings used herein are simply for convenience of the reader and are not intended to be understood as limiting or used for any other purpose.

Although various embodiments have been described above, the details and features of the disclosed embodiments are not intended to be limiting, as many variations and modifications will be readily apparent to those of skill in the art. Accordingly, the scope of the present disclosure is intended to be interpreted broadly and to include all variations and modifications within the scope and spirit of the appended claims and their equivalents. For example, any feature described for one embodiment may be used in any other embodiment.

1. An impact cradle for use in a loading zone of a conveyor having a conveyor belt, the impact cradle comprising:
a transversely extending base;
a first arcuate support;
a second arcuate support; and
at least a first impact pad removably engaging said first and second arcuate supports.

2. The impact cradle of claim 1, wherein said first arcuate support is parallel to said second arcuate support.

3. The impact cradle of claim 2, wherein said impact cradle has a width W extending between a first side thereof and a second side thereof, wherein first, second and third supports cooperatively support said impact cradle along an entirety of said width W.

4. The impact cradle of claim 1, further comprising:
a third arcuate support, said first impact pad at least partially supported on said third arcuate support, wherein said first and second arcuate supports are each disposed at a height above said third arcuate support at each transverse position along a width of the impact cradle.

5. The impact cradle of claim 1, wherein said impact cradle has a width W extending between a first side thereof and a second side thereof, wherein first, second and third arcuate supports cooperatively support said impact cradle along an entirety of said width W.

6. The impact cradle of claim 1, wherein said impact pad comprises a first undercut, said first undercut configured to receive at least a portion of said first arcuate support.

7. The impact cradle of claim 6, wherein said impact pad comprises a second undercut, said second undercut configured to receive at least a portion of said second arcuate support.

8. The impact cradle of claim 1, wherein said first impact pad is one of a plurality of impact pads, said plurality of impact pads being disposed along a width of the cradle.

9. The impact cradle of claim 8, wherein each of said plurality of impact pads includes first and second undercuts.

10. The impact cradle of claim 8, wherein each of said plurality of impact pads is removable from the cradle by sliding along said first and second arcuate supports.

11. An impact cradle for use in a loading zone of a conveyor having a conveyor belt, the impact cradle comprising:
at least a first impact pad;
a frame configured to releasably support said impact pad, said frame comprising:
a first arcuate support;
a second arcuate support; and
third arcuate support disposed below said first and second arcuate supports.

12. The impact cradle of claim 11, wherein said first arcuate support is parallel to said second arcuate support.

13. The impact cradle of claim 12, wherein said frame has a width W extending between a first side thereof and a second side thereof, wherein first, second and third supports cooperatively support said impact cradle along an entirety of said width W.

14. The impact cradle of claim 11, further comprising:
a third arcuate support, said first impact pad at least partially supported on said third arcuate support, wherein said first and second arcuate supports are each disposed at a height above said third arcuate support at each transverse position along a width W of said frame.

15. The impact cradle of claim 11, wherein said frame has a width W extending between a first side thereof and a second side thereof, wherein first, second and third supports cooperatively support said frame along an entirety of said width W.

16. The impact cradle of claim 11, wherein said impact pad comprises a first undercut, said first undercut configured to receive at least a portion of said first arcuate support.

17. The impact cradle of claim 16, wherein said impact pad comprises a second undercut, said second undercut configured to receive at least a portion of said second arcuate support.

18. The impact cradle of claim 11, wherein said first impact pad is one of a plurality of impact pads, said plurality of impact pads being disposed along a width of said frame.

19. The impact cradle of claim 18, wherein each of said plurality of impact pads includes first and second undercuts.

20. The impact cradle of claim 18, wherein each of said plurality of impact pads is removable from the cradle by sliding along said first and second arcuate supports.
